(19) United States
(12) Patent Application Publication
(10) Pub. No.: US 2016/0239613 A1
(43) Pub. Date: Aug. 18, 2016

(54) System and Method for Optimizing and Streamlining the Interaction and Relationship Between Patients and Healthcare Providers with a Smart Scheduler Process

(71) Applicant: docSynk LLC, Plano, TX (US)

(72) Inventor: Vaidyanatha Balasubramaniam Siva, Plano, TX (US)

(21) Appl. No.: 15/017,579

(22) Filed: Feb. 5, 2016

Related U.S. Application Data
(60) Provisional application No. 62/116,984, filed on Feb. 17, 2015.
(60) Provisional application No. 62/117,007, filed on Feb. 17, 2015.

(51) Int. Cl. G06F 19/00; G06F 17/30

(52) U.S. Cl. CPC G06F 19/327; G06F 17/30528; G06F 17/3053; G06F 17/30554; G06F 17/30864

(57) ABSTRACT

The system includes a database configured to store web pages of a web portal optimized for displaying on display screens of a variety of computing devices, a database configured to store profile data of a plurality of service providers, and feedback data associated with the plurality of service providers, including feedback data associated with identified friends and families of the user. A computer server is configured to receive user preferences for a service provider, and automatically create, in real-time, a rank ordered list of at least one service provider in response to the user preferences, the user's health insurance data, and feedback data associated with the plurality of service providers. The computer server is further configured automatically and in real-time identify an appointment time for the user in response to received two preferred time slots and service provider availability.

### RELATED APPLICATIONS

The present application claims the benefit of U.S. Provisional Patent Application No. 62/116,984 filed on Feb. 17, 2015, entitled “Method and System for Managing Patient-Provider Relationships in Healthcare,” and U.S. Provisional Patent Application No. 62/117,007 filed on Feb. 17, 2015, entitled “Method and System for Elimination of Wait-Times for Visits at the Healthcare Provider,” both of which are incorporated herein by reference.

### FIELD

The present disclosure relates to the field of healthcare services, and in particular to a system and method for optimizing and streamlining the interaction and relationship between patients and healthcare providers with a smart scheduler process.

### BACKGROUND

Patients may rely on a wide variety of healthcare providers across a continuum of healthcare and wellness services, such as primary care physicians, specialists (such as cardiologists, obstetrician-gynecologists, pediatricians, oncologists, podiatrists, orthopedics, psychologists, etc.), laboratories, imaging centers (radiology), specialty centers (such as oncology), dentists, oral surgeons, orthodontists, vision centers (optometrists), dieticians, chiropractors, physiotherapists, accupuncturists, massage centers, psychiatry, alternate medicine, and wellness centers, etc. As society embraces a more holistic view of healthcare, the line between traditional notions of healthcare (hospital visits) and wellness (preventive care) becomes blurred. A healthful life now demands a new focus on managing the entire continuum of wellness and healthcare, through all the individual interactions with all healthcare providers in a holistic manner.

There is now realization that individuals and families need a way to optimize and streamline the interactions and relationships with all of their healthcare and wellness service providers.

### BRIEF DESCRIPTION OF THE DRAWINGS

FIG. 1 is a simplified block diagram of an exemplary embodiment of a system and method for optimizing and streamlining the interaction and relationship between patients and healthcare providers according to the teachings of the present disclosure;

FIG. 2 is a simplified flowchart of an exemplary embodiment of a method for optimizing and streamlining the interaction and relationship between patients and healthcare providers according to the teachings of the present disclosure;

FIG. 3 is a more detailed flow diagram of an exemplary embodiment of a method for optimizing and streamlining the interaction and relationship between patients and healthcare providers according to the teachings of the present disclosure;

FIG. 4 is a simplified flow diagram of an exemplary embodiment of a method for an initial account creation for optimizing and streamlining the interaction and relationship between patients and healthcare providers according to the teachings of the present disclosure;

FIG. 5 is a simplified flow diagram of an exemplary embodiment of a method for a provider smart search for optimizing and streamlining the interaction and relationship between patients and healthcare providers according to the teachings of the present disclosure;

FIG. 6 is a more detailed flow diagram of an exemplary embodiment of a method for provider search for optimizing and streamlining the interaction and relationship between patients and healthcare providers according to the teachings of the present disclosure;

FIG. 7 is another simplified flow diagram of an exemplary embodiment of a method for a provider appointment scheduling for optimizing and streamlining the interaction and relationship between patients and healthcare providers according to the teachings of the present disclosure;

FIG. 8 is another simplified flow diagram of an exemplary embodiment of a method for an appointment queue analysis for optimizing and streamlining the interaction and relationship between patients and healthcare providers according to the teachings of the present disclosure;

FIG. 9 is another flow diagram of an exemplary embodiment of a method for an appointment queue analysis for optimizing and streamlining the interaction and relationship between patients and healthcare providers according to the teachings of the present disclosure;

FIG. 10 is a summary diagram of an exemplary embodiment of the smart service provider search process for optimizing and streamlining the interaction and relationship between patients and healthcare providers according to the teachings of the present disclosure;

FIG. 11 is a summary diagram of an exemplary embodiment of the smart appointment scheduling process for optimizing and streamlining the interaction and relationship between patients and healthcare providers according to the teachings of the present disclosure;

FIGS. 12-25 are exemplary screen shots of an exemplary embodiment of a method for an appointment queue analysis for optimizing and streamlining the interaction and relationship between patients and healthcare providers according to the teachings of the present disclosure; and

FIG. 26 is a simplified block diagram of an exemplary embodiment of a mobile terminal capable of accessing the system and method for optimizing and streamlining the interaction and relationship between patients and healthcare providers.

### DETAILED DESCRIPTION

Selecting a physician or other healthcare or wellness service providers can be a daunting task for most people. Some factors to consider when choosing a physician include reputation, location, gender, specialty, language spoken, health plan and hospital affiliations, etc. Many solicit recommendations from friends and family members, and others consult the database of their state's medical board. To add to the complexity, the healthcare insurance coverage can largely contract the pool of providers that individuals and families can use. There are different types of health insurance plans designed to meet different needs of individuals and families. Some types of plans restrict provider choices or give preference to providers who belong to the plan's network of doctors, hospitals, pharmacies, and other medical service providers. Some plans require the patient to pay a greater share of costs for providers outside the plan's network. Another challenge between a patient and her service providers is the provider-centric system, in which patients are often required to wait an hour or more at the doctor's office to see the doctor, or in the lab waiting room to provide urine or blood samples. What is desirable is an all-in-one comprehensive system that helps to optimize and streamline the interface and interaction between patients and all of her doctors, or between users and all of her service providers.

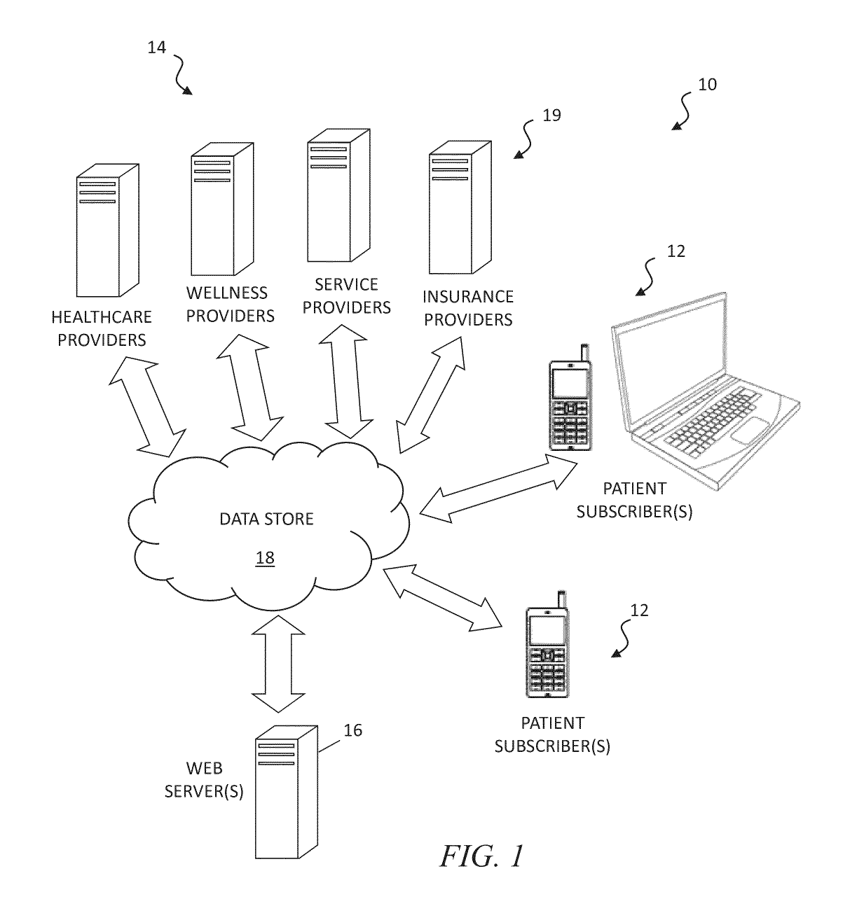

FIG. 1 is a simplified block diagram of an exemplary embodiment of a system and method 10 for optimizing and streamlining the interaction and relationship between patients 12 and healthcare providers 14 according to the teachings of the present disclosure. The system and method 10 described herein provides a portal and marketplace that connect patients 12 and service providers 14 (healthcare providers, wellness providers, and other service providers may be hereinafter referred collectively as service providers), and further provides a one-stop-shop for patients 12 to manage all of his or her wellness relationships. The patients 12 are subscribers or otherwise enrolled as users of the system 10, and may access the system 10 using software executing on a variety of computing and communication devices, including but not limited to mobile telephones, laptop computers, tablet computers, desktop computers, and wearable devices now in existence or developed in the future. The system 10 includes one or more websites serving as a portal accessible by the patients 12 and stored in a computer server 16. The server 16 may have access to local co-located database(s) as well as a cloud-based databases 18, which may be distributed in multiple geographic locations with redundancy and load balancing capabilities. The databases are configured to store service provider data, user account data, including profiles, preferences, insurance and billing information, and favorite service provider data.

The system and method 10 are further capable of automatically communicating with health insurance providers 19 and accessing insurance policy information, including the coverage of the policies and service providers included in their physician, hospital, and other service provider networks. The system and method may access service provider and insurance provider data on a real-time basis to obtain the most up-to-date information and/or receive periodic updates therefrom. The system and method further automatically communicates with service providers' electronic calendaring system to obtain availability information. Further, the system and method may also automatically communicate with one or more social media sites to obtain or post service provider favorability ratings or rankings. The system and method may also automatically access (with permission) the user's contact data to obtain the identity of the user's family and friends.

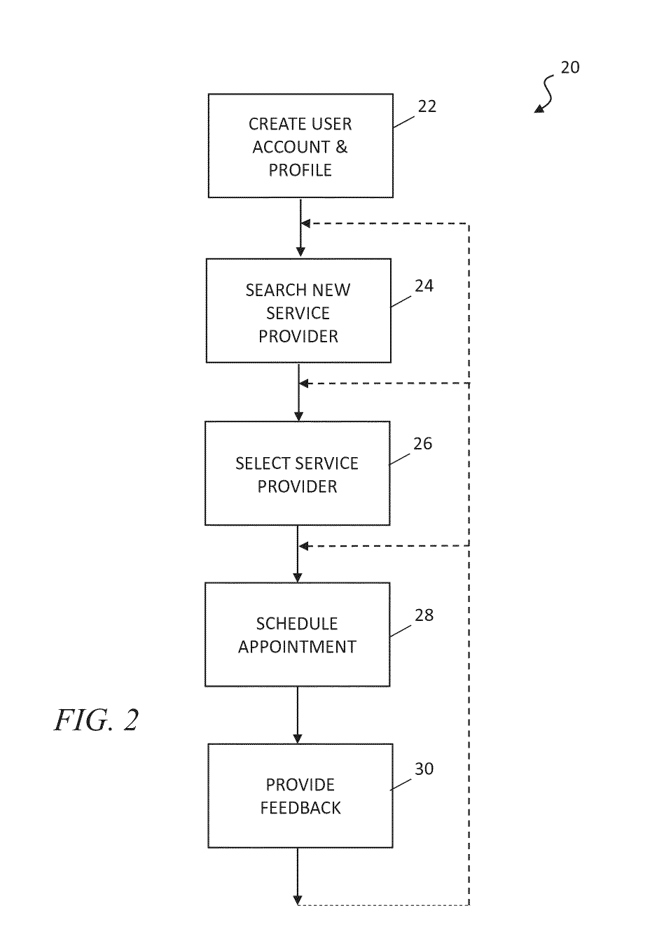

FIG. 2 is a simplified flowchart of an exemplary embodiment of a method 20 for optimizing and streamlining the interaction and relationship between patients and healthcare providers according to the teachings of the present disclosure. To access and use the system, the patient first creates a user account and provide information about him/herself to create a user profile, as shown in block 22. The patient may be asked to provide a unique user name and a valid email address to create the user account. The system may also request the patient to set up two-factor authentication for enhanced security and privacy. The patient is prompted to supply the correct login information in order to access the portal. The user is then prompted to enter information such as name, age, gender, date of birth, home address, telephone number, health insurance data (e.g., health insurance provider name and contact information, and group and member ID), and billing information (e.g., billing address, credit card number, etc.). The user may also be prompted to provide personal preferences for healthcare providers, such as preferences for location, appointment date/time (office hours), gender, college affiliations, years of experience, healthcare philosophy, reputation, etc. Patient preferences are unconstrained and can be completely personalized. The preferences may be represented by tuples in the form (<key, value>pairs). For example, a preference can be represented as (distance from home, <5 miles). Once the user account and profile are set up, the patient may proceed to use the portal for her healthcare needs.

The user may set up an account that includes one or more members of her immediate family, and to provide profile information for each member of the family. Those members of the family that are over 18 years of age may also set up their own login and authentication information to access their own healthcare information.

In block 24, the user may search for a new healthcare provider, wellness provider, or another type of service provider, such as primary care physicians, specialists (such as allergists/immunologists, anesthesiologists, audiologists, cardiologists, obstetrician-gynecologists, pediatricians, oncologists, podiatrists, orthopedics, psychologists, etc.), laboratories, imaging centers (radiology), specialty centers (such as oncology), dentists, oral surgeons, orthodontists, vision centers (optometrists), dieticians, chiropractors, physiotherapists, accupuncturists, massage centers, psychiatry, alternate medicine, and wellness centers, etc. The search process takes into account the user's preferences and insurance information to present the best options to the user. Details of the service provider search process are presented below. The user then may select a service provider from the options presented by the system, and proceed to schedule an appointment for a visit, as shown in blocks 26 and 28. Details of this appointment scheduling process are presented below. After the appointment with the service provider, the patient is prompted to provide feedback about the visit with the service provider, as shown in block 30. This feedback information is analyzed to optimize future service provider searches. Details of the feedback analysis process are provided below.

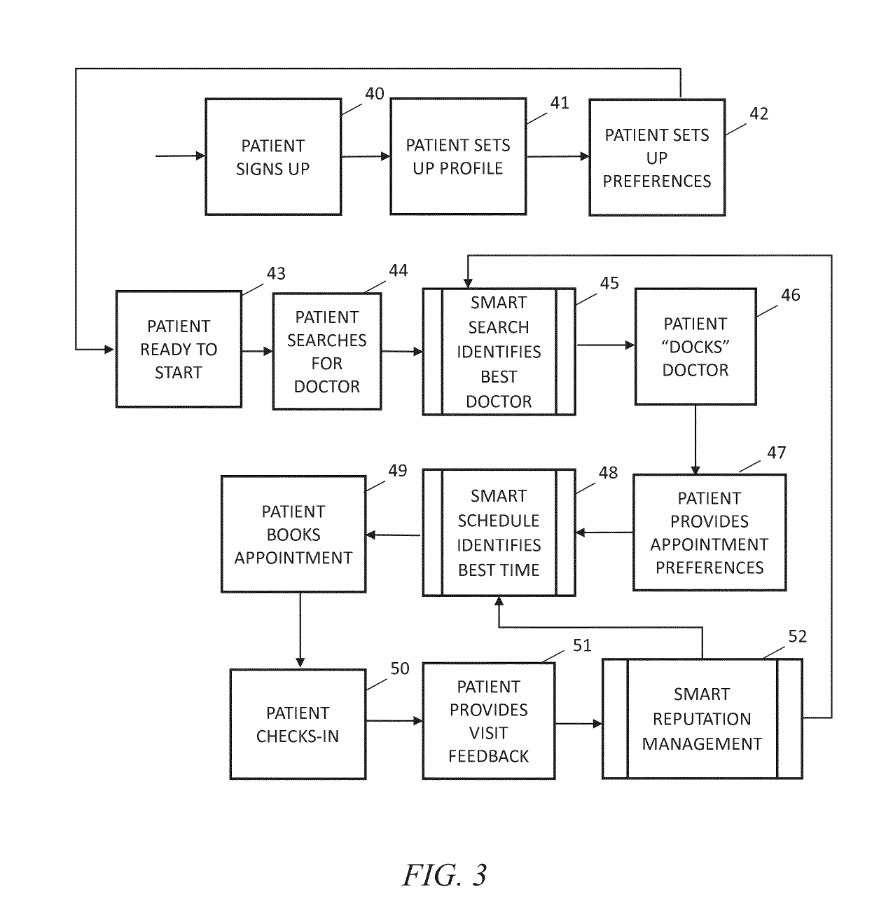

FIG. 3 is a more detailed flow diagram of an exemplary embodiment of a method for optimizing and streamlining the interaction and relationship between patients and healthcare providers according to the teachings of the present disclosure. In block 40, the patient indicates his/her desire to sign up or become a user. In block 41, the patient is prompted to provide account and profile information (including user verification/authentication data), which is received by the system and stored in its user database. The patient is also prompted to provide preferences for the service provider, which are also received and stored, as shown in block 42. In block 43, once the patient has set up an account and provided profile and preference information, he/she is ready to begin using the portal. In block 44, the user may search for a service provider by entering one or more search criteria. For example, the user may indicate that she is looking for a new cardiologist. In block 45, a smart search process is then automatically initiated that identifies, in real-time, the best cardiologist(s) that best matches the patient's search criteria, including her preferences and ranking and feedback from other patients, including her family and friends. The novel search process uses a weighted graph theory ranking process and a rank order algorithm that leverages a host of inputs to rank order the available service providers based on the search criteria, preferences, and health insurance policy of the patient, as well as feedback data collected from other users (with more weight assigned to the user's family and friends). The user may click on one of the service providers in the recommended list and obtain more information about that service provider, such as a brief profile displayed on-demand. The system and method may also display an icon that enables the user to call the service provider directly or to schedule an appointment. The user then selects one service provider from the ranked list of best matches and adds the selected service provider to her preferences or favorites, as shown in block 46.

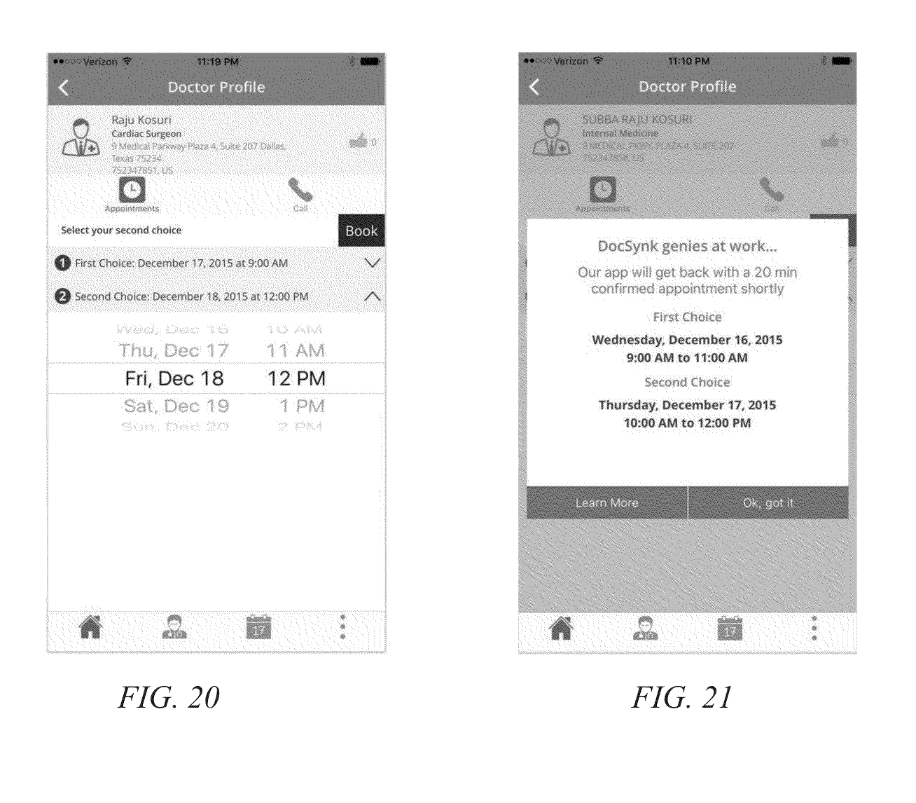

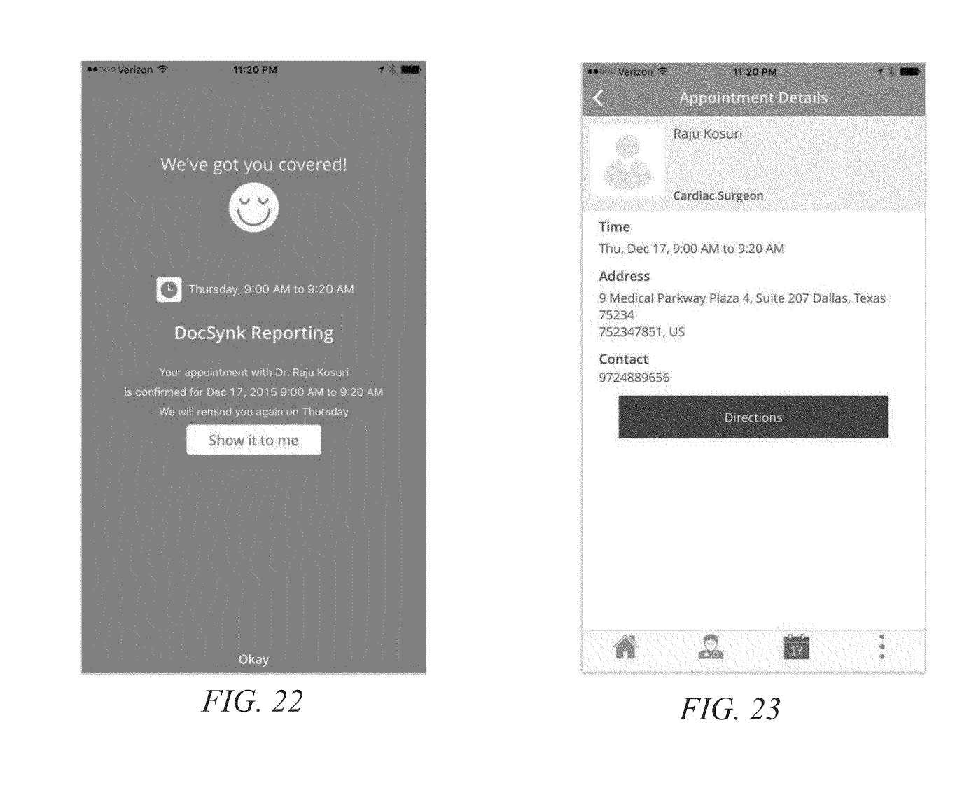

Thereafter, the patient may schedule an appointment with the selected service provider (or another provider already stored in her favorites folder), by first providing a reason for the visit and her appointment date/time preferences, as shown in block 47. An exemplary screen shot of a mobile app to receive a user's input of the reason for the visit is shown in FIG. 19. A scheduling process then prompts the user to enter two two-hour time slots during which she would like to have the office visit. The system and method then automatically identify, in real-time, one or more appointment times that are available, taking into account of the patient's preferences and feedback from the service provider's other patients, as shown in block 48. An exemplary screen shot of a mobile app displaying two appointment time slots entered by the user is shown in FIG. 20, and an exemplary screen shot of a mobile app informing that a scheduling is working on selecting an appointment time is shown in FIG. 21. The patient then books the appointment, as shown in block 49. An exemplary screen shot of a mobile app displaying the user's appointment confirmation is shown in FIG. 22, and an exemplary screen shot of a mobile app displaying the user's appointment details is shown in FIG. 23.

The system and method may automatically send a reminder (phone call, text message, calendar reminder, etc.) to the user on the day of the appointed time. Thereafter in block 50, the patient may check-in using the mobile app prior to arriving at the service provider's office. After the visit, the patient may receive a prompt (in the form of an email, text message, etc.) automatically generated by the system and method to provide feedback on the visit and on the service provider, as shown in block 51. The patient's textual and/or verbal feedback and comments (can also be in the form of responses to survey questions, a thumbs up/down, or star-based rating) are received by the system and stored in its database with an association with the particular service provider. In block 52, the feedback is provided to a service provider reputation management process, which analyzes the feedback and generates data that are provided as inputs to the service provider search process 45 and the appointment scheduling process 48.

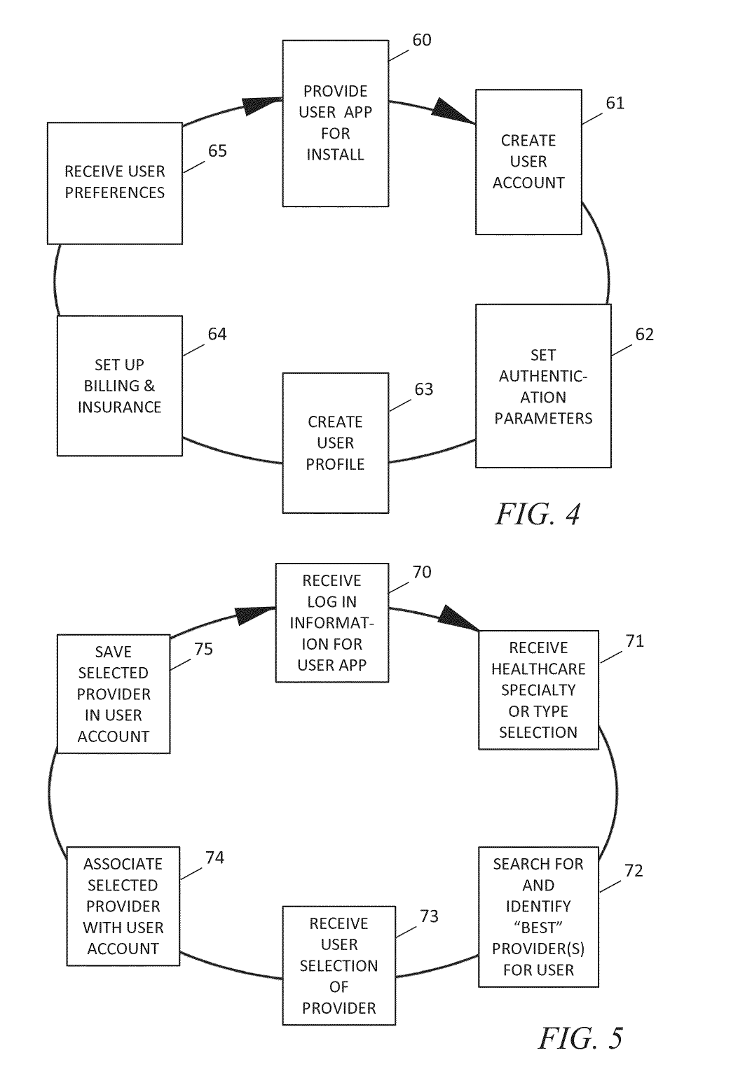

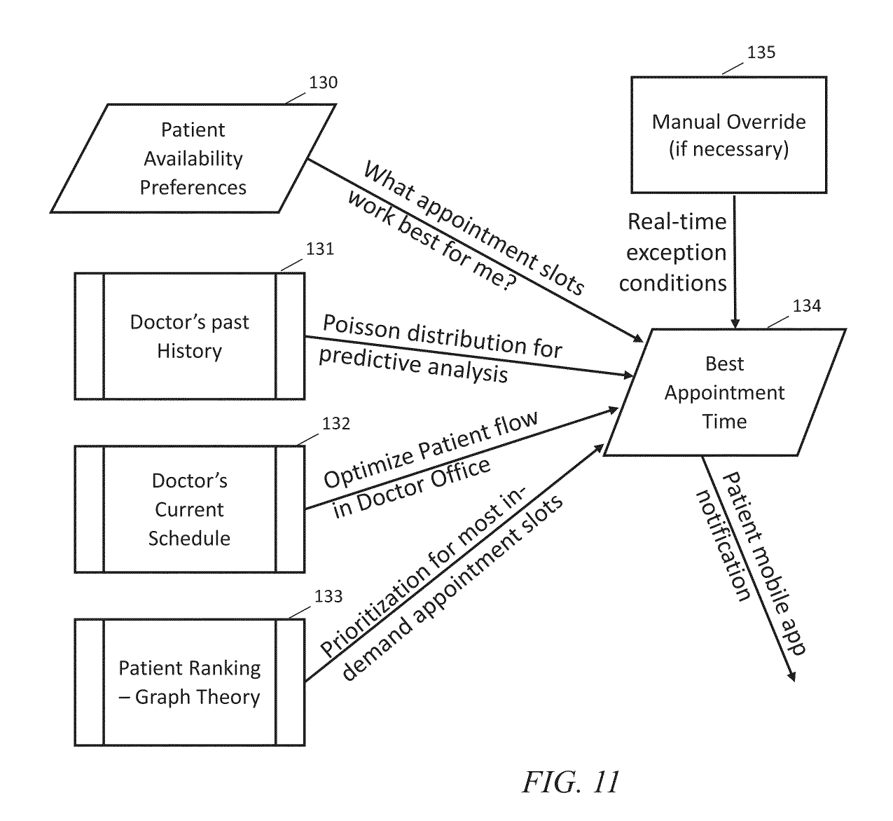

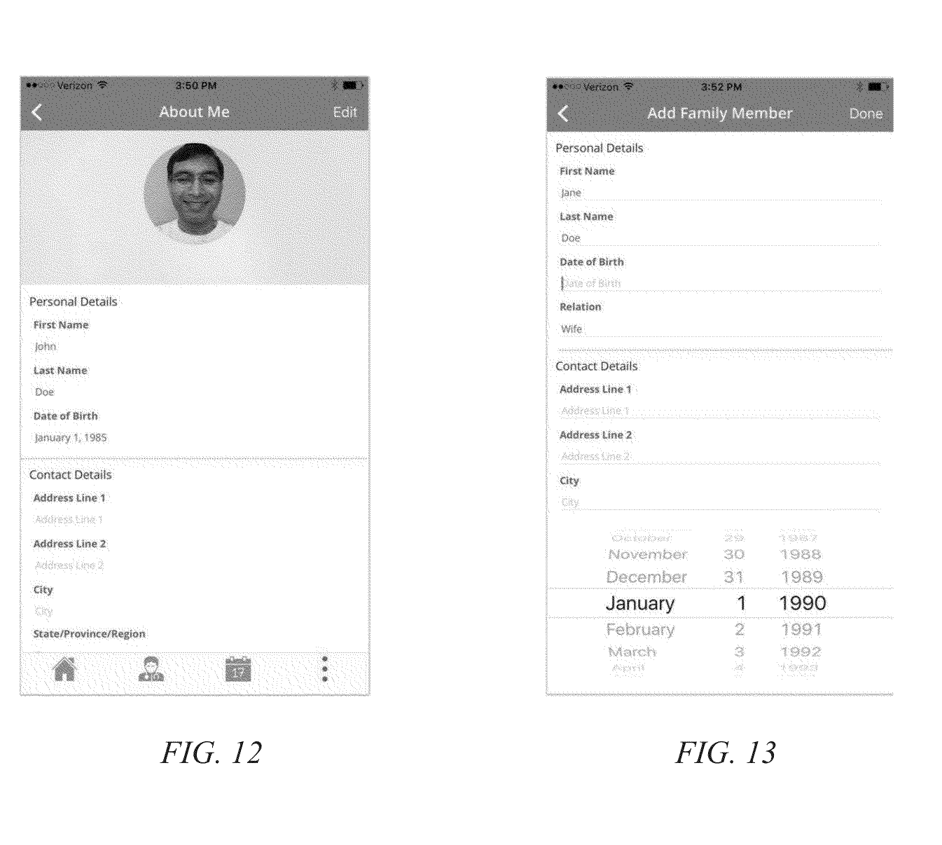

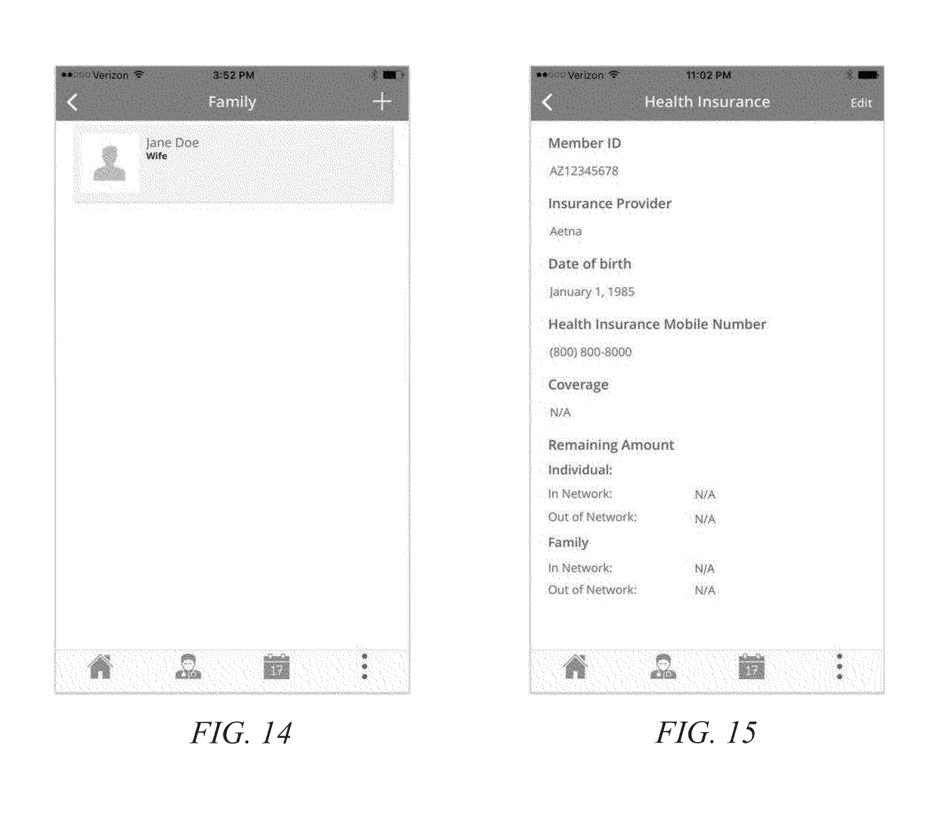

FIG. 4 is a more detailed flow diagram of an exemplary embodiment of a method for an initial account creation for optimizing and streamlining the interaction and relationship between patients and healthcare providers according to the teachings of the present disclosure. The system and method are configured to provide the user the necessary software or mobile app for the appropriate computing platform to access the portal, as shown in block 60. The user may download the software from the portal or from an app store, for example. The system and method then creates the user account, based on information provided by the user, as shown in block 61. Further in block 62, the system and method sets up the authentication parameters for two-factor authentication, for example. The system and method further sets up the user profile with information provided by the user, such as name, age, gender, date of birth, address, telephone number, etc., as shown in block 63. An exemplary screen shot of a mobile app displaying a user's profile data is shown in FIG. 12. The user's billing and insurance information are also received by the system and method and stored properly in the database, as shown in block 64. An exemplary screen shot of a mobile app displaying a user's profile data including insurance information is shown in FIG. 15. Further, the user's preferences are also received and stored properly, as shown in block 65.

The user may set up an account that includes one or more members of her immediate family, and to provide profile information for each member of the family. An exemplary screen shot of a mobile app displaying how a family member may be added to the user's profile data is shown in FIG. 13. Those members of the family that are over 18 years of age may also set up their own login and authentication information to access their own healthcare information. An exemplary screen shot of a mobile app displaying one or more family members of a user's profile data is shown in FIG. 14.

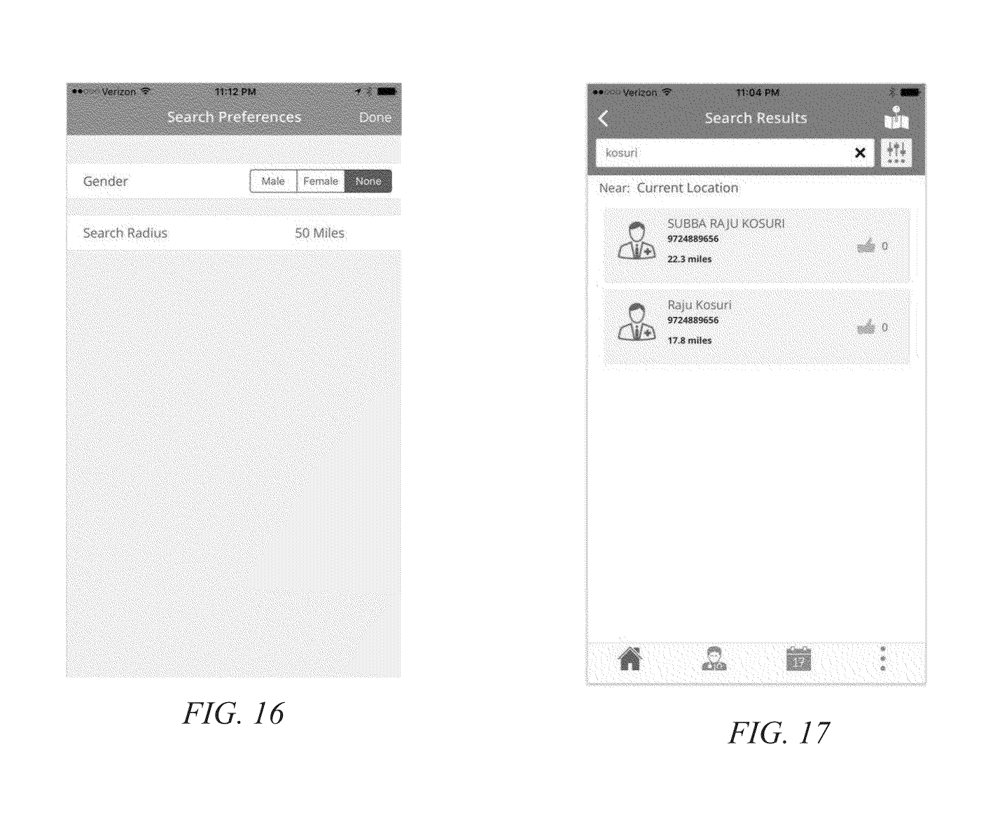

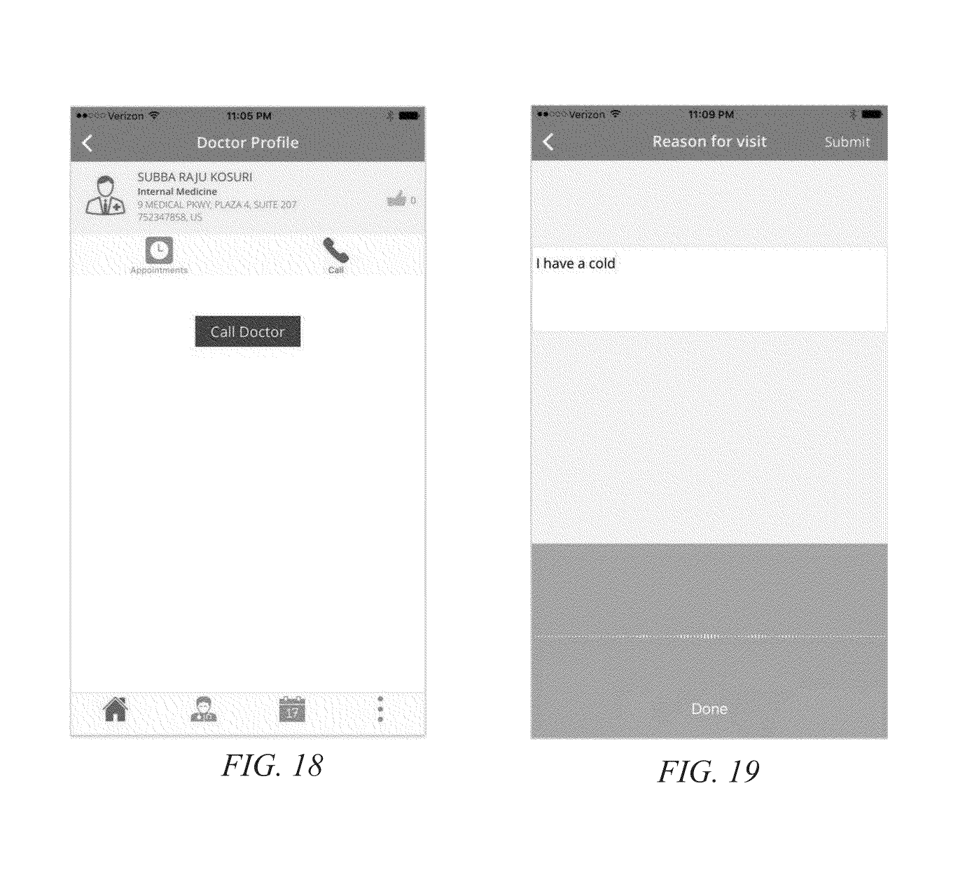

FIG. 5 is a more detailed flow diagram of an exemplary embodiment of a method for a provider smart search for optimizing and streamlining the interaction and relationship between patients and healthcare providers according to the teachings of the present disclosure. In block 70, the system and method receives the user's login information and provides access if the login information entered by the user matches the user's login information stored in the database. The user then enters or selects a healthcare or wellness specialty or type, which is received by the system and method, as shown in block 71. A search is then conducted to identify the “best” service provider for the user, based on the user's preferences, search criteria (e.g., specialty area, gender, academic credentials, years of practice, and insurance policy), service provider reputation rankings, etc., as shown in block 72. An exemplary screen shot of a mobile app displaying a user's search criteria is shown in FIG. 16. The search process uses a novel “rank order” algorithm that leverages a host of search criteria or inputs to rank order the service providers. The system and method may present a ranked list of top three service providers that best match the search criteria. An exemplary screen shot of a mobile app displaying a rank-ordered search result is shown in FIG. 17. Each identified service provider may be presented with brief and detailed profile information to enable the user to make her final decision. An exemplary screen shot of a mobile app displaying a service provider's profile information is shown in FIG. 20. The user then selects one service provider from the rank-ordered list, which is then associated with the user and saved by the system and method in its database, as shown in blocks 73-75.

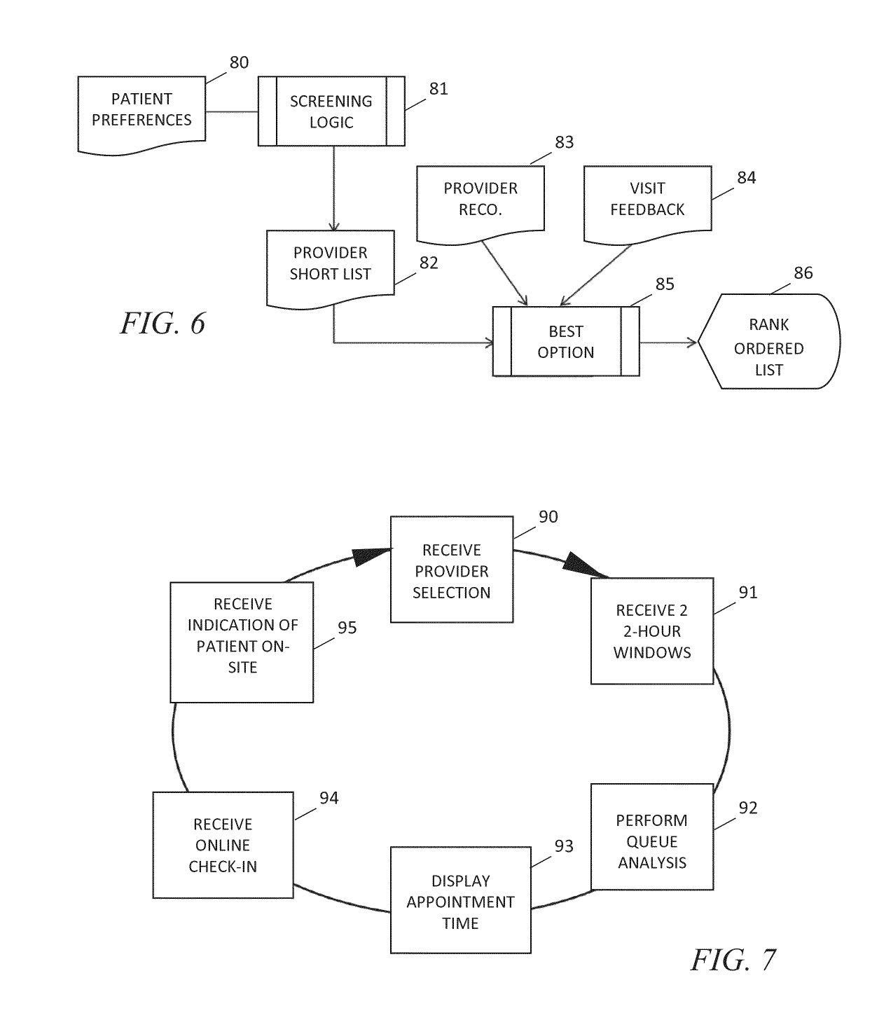

FIG. 6 is a more detailed flow diagram of an exemplary embodiment of a method for provider search for optimizing and streamlining the interaction and relationship between patients and healthcare providers according to the teachings of the present disclosure. The patient's preferences 80 are used as the primary input for the search. The system uses the user's preferences as screening criteria or logic 81 to screen or filter out service providers that do not meet the screening criteria, and 2) create a short list 82 of service providers that do meet the screening criteria. The system further uses additional inputs including service provider feedback 83 and visit feedback 84 from other users (including feedback from the user's own family and friends) to arrive at the best options 85 for the user. The best options 85 is preferably in the form of a rank-ordered list 86 of the top three to five service providers that are highly recommended to the user. This process enables the user to make a sound choice for the service provider that is best suited for the user and best meets her needs.

FIG. 7 is another simplified flow diagram of an exemplary embodiment of a method for service provider appointment scheduling for optimizing and streamlining the interaction and relationship between patients and healthcare providers according to the teachings of the present disclosure. In block 90, the system and method receives the user's selection of the service provider, which may be one of the recommendations in the rank-ordered list generated based on user preferences, insurance policy, and feedback from other users. The user is further prompted to provide two two-hour windows of time during which the user would like to schedule the office visit, as shown in block 91. The system and method then run a novel queuing theory model using Markov Chains in a Poisson distribution, using service provider availability during the two two-hour time blocks, service provider's past schedule patterns (for predictive analysis), historical arrival rates, wait times, and service rates at the selected service provider's office, as well as the patient's “lifetime value” to determine the best option for the appointment, as shown in blocks 92 and 93. The system and method analyze patient data in a novel graph analysis ensemble to rank patients by lifetime value to prioritize the most in-demand appointment time slots. For example, certain long-time patients are given higher priority to in-demand appointment time slots. Queuing theory and constraint-based optimization models are used to identify the best time for the visit to eliminate or minimize patient wait time, and optimize overall patient flow. The best appointment time option is presented or displayed as a starting time for a 20-minute window for which the patient may schedule her visit. The service provider may configure the system and method to have shorter or longer appointment time slots. The best appointment time window is identified by the system and method as the time when there is the shortest queue of patients at the office and represents the best time for the service provider to make a zero-wait time commitment for the patient, with minimum or no disruption. The system also prompts the user to provide a reason for the appointment, and uses a novel semantics technology to translate the patient's articulated reason to the current procedural terminology (CPT) code. The service provider office then, using the portal, accepts the best appointment time option and the patient is scheduled for the office visit.

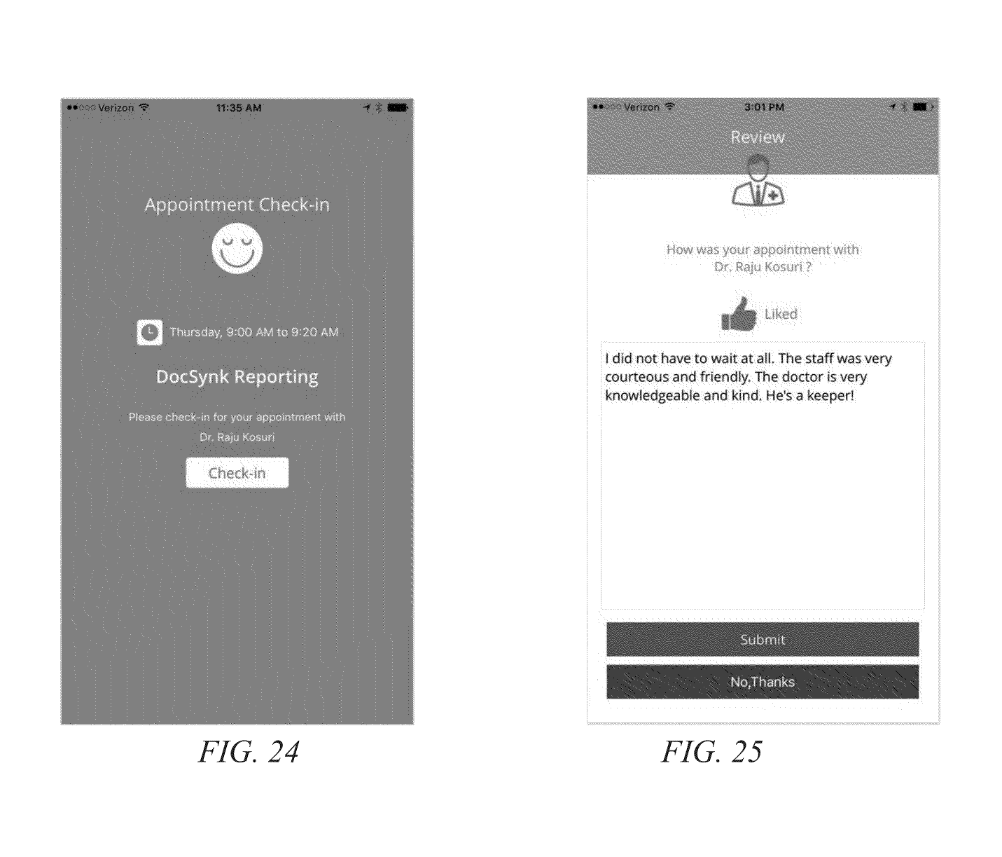

On the day of the appointment the mobile app or software alerts the patient of the 20-minute window and allows the patient to check-in on the day of the appointment using the mobile app, as shown in block 94. An exemplary screen shot of a mobile app displaying a check-in screen is shown in FIG. 24. The system may proceed to bill and charge a co-pay for the visit per the patient's insurance policy. Once the patient checks-in, the system and method, securely and privately, and in the background, shares the already verified insurance information with the service provider. The service provider can, if necessary, run any additional checks at their end, to ensure that all information (e.g. coverage and copay information) is validated. When the patient shows up at the service provider's office, as shown in block 95, all validations have already happened and there is no queue (or minimal queue) at the office, enabling the provider to see the patient with the least disruption to others.

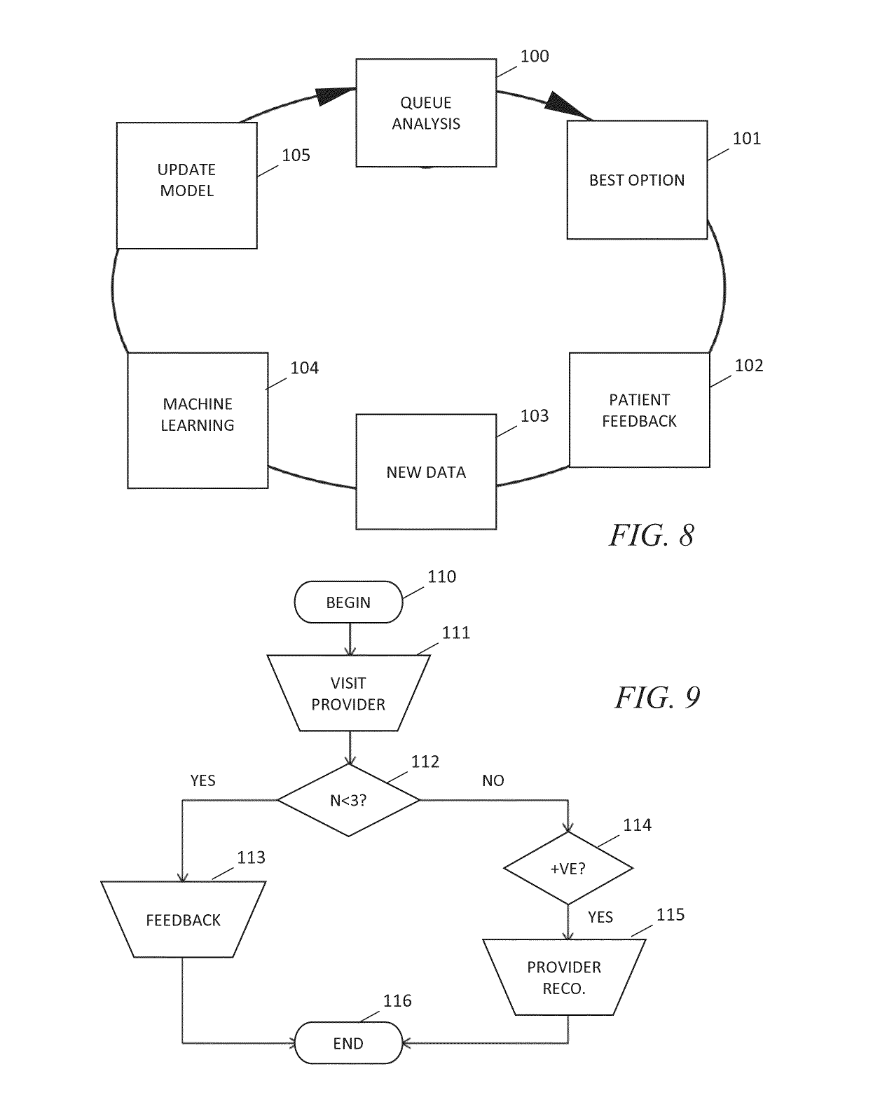

FIG. 8 is another simplified flow diagram of an exemplary embodiment of a method for an appointment queue analysis for optimizing and streamlining the interaction and relationship between patients and healthcare providers according to the teachings of the present disclosure. The system and method receives two two-hour preferred time windows for an appointment from the user, and the system performs queue analysis to generate a recommended appointment time, as shown in block 100. The system and method uses data including arrival rates, wait times, etc. previously provided or received in real-time from the service provider, and queuing theory (a Markov process) to identify the best 20-minute time window for the user to visit the service provider, as shown in block 101. The user may then proceed to accept the recommended time and schedules the appointment. On the day of the appointment, the user is prompted to check-in online so that patient information (profile, insurance, and billing) can be transmitted to the service provider for validation. After the visit, the patient is prompted to provide feedback on the service provider and the visit, as shown in block 102. The feedback may be in the form of textual or speech input, or may be in the form of a survey, star-based rating, or thumbs up/down. The patient can “like” the service provider and the office visit. An exemplary screen shot of a mobile app displaying a screen for receiving user feedback is shown in FIG. 25. The system may perform voice recognition and sentiment analysis on the feedback input to determine whether the feedback was positive, neutral, or negative. Such feedback is aggregated across all patients and used in future ranking and machine-learning analyses. In addition, at least on a weekly basis, system information is polled from the service provider's office (arrival rates, wait times, etc.). A machine learning approach (block 104) is used to further refine the model parameters using 1) crowd-sourced patient feedback and 2) system data (at least weekly) to update and refine the model and improve efficacy of the best option, as shown in block 105.

FIG. 9 is another flow diagram of an exemplary embodiment of a method 110 for an appointment feedback for optimizing and streamlining the interaction and relationship between patients and healthcare providers according to the teachings of the present disclosure. After each visit to a service provider's office, as shown in block 111, the patient has the ability to rate and provide feedback on the visit. She can assign, for example, a star rating (1 to 5 stars) to the most recent visit and can provide any textual feedback on the visit, as shown in block 113. She can provide this feedback for each visit. Once she has visited the provider 3 times, as determined in block 112, she has the option to give a positive recommendation of the service provider, as shown in blocks 114 and 115. This can be done only once for each service provider. A recommendation is weighted higher in the rank-order algorithm. If a patient changes her mind, subsequently, she can also revoke the recommendation. The patient's feedback and/or recommendation can be posted to one or more social media sites, with the patient's and the service providers advanced permission. Negative feedback is provided to the service provider so that the service provider may take steps to engage with the patient and remedy the negative experience. The process ends in block 116.

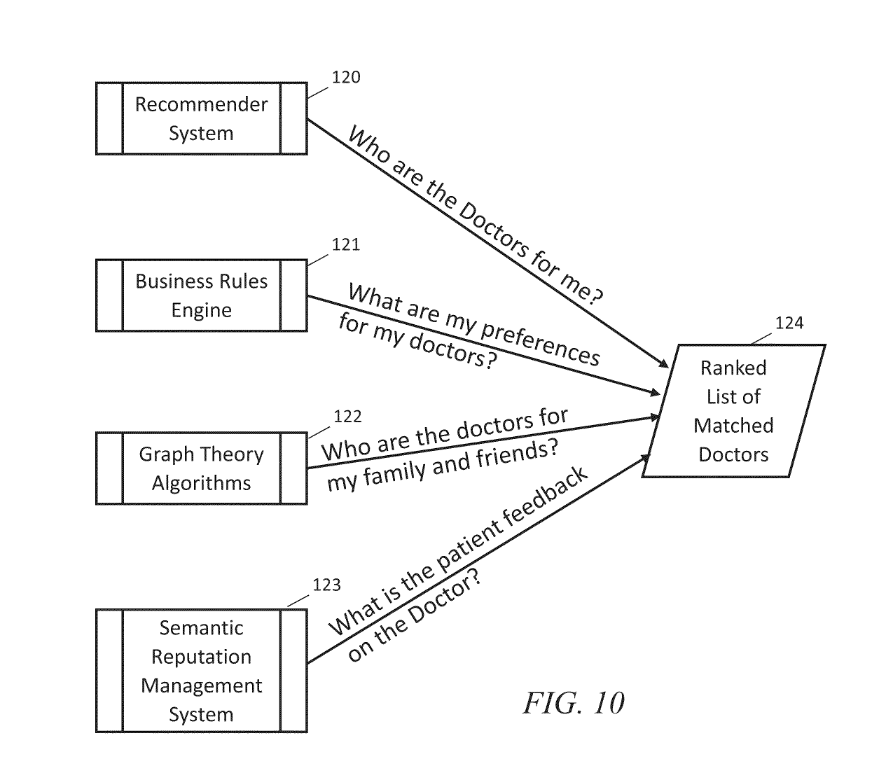

FIG. 10 is a summary diagram of an exemplary embodiment of the smart service provider search process for optimizing and streamlining the interaction and relationship between patients and healthcare providers according to the teachings of the present disclosure. The system and method 10 described herein includes a unique combination of a) recommender system 120, b) personalized business rules 121, c) graph theory algorithms 122, and d) semantic-aware reputation management system 123 to match doctors to patients to arrive at a rank-ordered list 124 of matched doctors best suited to the patient. This combination of techniques and technologies is used in a continuously improving, self-learning, closed-feedback loop.

Recommender systems 120 typically produce a list of recommended service providers through the use of collaborative and/or content-based filtering. Collaborative filtering builds a model from a user's past behavior (items previously purchased or selected and/or numerical ratings given to those items) as well as similar decisions made by other users. This model is then used to predict items (or ratings for items) that the user may have an interest in. Collaborative filtering uses latent factor models as the underlying mechanism and requires a large size of data elements. Content-based filtering utilizes a series of discrete characteristics of an item in order to recommend additional items with similar properties. Content-based filtering uses specific pre-defined properties (that are proprietary to its logic) such as e.g., specialty, education, experience that are used to match doctors for patients, based on those properties. Over time, patient feedback improves the filtering logic.

The system and method leverage a closed-feedback loop, self-learning (based on patient feedback) hybrid recommender system that combines both filtering approaches. This combined approach avoids the “cold start” problem in cities where there is not enough seed data for collaborative filtering to be effective, and fully leverages the power of the collaborative filtering approach for non-obvious, correlational matches based on latent factors. Further, the system and method use both filtering approaches and leverage a proprietary set-theory based approach to determine the right intersection of results to find the best set of recommendations of service providers for the patient.

The business rules engine 121 primarily operates on the user's preferences and uses these preferences as a screening criteria to reduce the pool of eligible service providers. The business rules engine puts the patient's preferences front-and-center in the doctor search process. The rules allow for complete extensibility and personalization for the patient's needs in addition to standard business rules such as membership in insurance-defined network. The business rules are enabled by the way the rules are stored in the databases—as tuples (key-value pairs) with no limitation. The user/patient may define whatever requirement he/she wishes to apply. For example, one patient may wish to look for an OB-Gyn that is female. Another example is that another patient may wish to find a Cardiologist with more than 20 years of experience. These constraints are not pre-determined and are completely personalized based on the patient's wishes.

The graph theory algorithms 122 may use weighted graphs to identify and rank service providers used by family and friends. The more links from friends and family to a particular service provider produces a higher ranking for that service provider. Patients are able to view the service providers of their first level connections (family and friends) anonymously, so that that they are able to identify those service providers but not who the patients are. So John Doe would know that Dr. Ortho Pedist is a doctor of one of his first-level connections but would not know for which friend or family member. The system and method use an egonet-based approach and Pregel algorithms (page rank algorithm) to determine the intersections of the sub-graphs of a patient's service providers, of the service providers of the patient's family members, and of the service providers of the patient's friends. The system and method can employ information obtained from social media in this manner and still be HIPAA compliant.

Sentiment analysis is used in semantic reputation management 123 and refers to the use of natural language processing, text analysis, and computational linguistics to identify and extract information, in this case, feedback and comments about a service provider. The information is extracted and fed to the smart search process used to identify service providers. After a doctor visit a patient has the opportunity to provide (via speech or raw text) feedback about the visit. A semantic aware, sentiment analysis engine is used to evaluate the feedback and classify it, automatically, into three classes—1) positive, 2) negative, and 3) neutral. If the sentiment engine evaluates the raw feedback (speech or raw text) as negative, this feedback is immediately relayed to the service provider to remedy the situation with the patient. If the sentiment engine evaluates the raw feedback (speech or raw text) as neutral, the feedback is ignored. If the sentiment engine evaluates the raw feedback (speech or raw text) as positive, this feedback is entered into the smart search process. In addition to speech/text feedback, the patient also has the ability to “like” the visit. A combination of all “likes” and positive feedback (as automatically classified by the sentiment analysis engine) is used to rank-order the short-listed doctors that are matched for the patient by the smart search process.

The system and method also employ queueing theory to determine the best appointment time for the patent. Queuing theory is the mathematical study of waiting lines, or queues. In queueing theory a model is constructed so that queue lengths and waiting time can be predicted. Queueing theory is generally considered a branch of operations research because the results are often used when making business decisions about the resources needed to provide a service.

FIG. 11 is a summary diagram of an exemplary embodiment of the smart appointment scheduling process for optimizing and streamlining the interaction and relationship between patients and healthcare providers according to the teachings of the present disclosure. The system and method 10 described herein includes a combination of a) the patient's availability preferences 130, b) doctor's past schedule history 131, c) doctor's current schedule workload 132, and d) patient ranking based on lifetime value 133 to determine a best appointment time for the patient. The patient preference for appointment time is the driver or primary factor for determining the appointment time, rather than just the available time slots in the service provider's calendar. The patient provides preferences that work for her and the smart scheduler works, in an automated manner, to find appointments that work within her constraints. This scheduling process yields dramatically reduced wait time for the patient, and optimized patient flow for the service provider. The smart scheduler process puts the patient in charge of her healthcare and the entire patient experience.

When a service provider is first set up in the system, the service provider's historical schedule history (calendar information) are received as input. This historic information is used to understand the pattern of patient arrival rates and the amount of time used for patient visits, from an aggregate perspective. The schedule predictive analysis approximates the historical schedule with a Poisson distribution model, which is used to predict future appointment slots that have more probability of being available, in future searches for doctor appointments. Also during service provider setup, a batch feed is set up for future service provider schedule information (calendar appointment details) that is uploaded to the system on a nightly basis. The future appointment schedule information, in conjunction with the Poisson distribution model based on past schedule history, serves as an approximation for expected calendar, including busy-times and fallow-times. The system and method use an optimization algorithm to optimize patient appointment to meet her appointment preferences and eliminate wait-times during the visit, and doctor schedule, to optimize patient flow (smooth out crests and troughs, and increase overall throughput of patients through the doctor office).

The smart scheduler further employs patient ranking to schedule visits. Not all patients are the same. Some patients are purely transactional and use a standard Doctor SEO (search engine optimization) system for a one-time, tactical doctor visit for just one problem. Once that visit happens, the patient never visits the doctor again. Some believe that, fundamentally, this transactional approach to healthcare is sub-optimal. A deep and fully-engaged patient-doctor relationship provides better diagnosis, less expensive and irrelevant tests, better patient outcomes, and reduced healthcare costs. This common-sense, patient-centric approach to healthcare is missing today from similar online doctor search services. This is why the present system and method described herein go through an elaborate patient-doctor match, to find the right doctor for the patient, to enable a deep, engaged patient experience. The present system and method use egonets and Pregel (page rank) algorithms to rank-order patients based on their lifetime value. A number of attributes are used, in a weighted approach, including: patient engagement history (longer history with doctor, higher lifetime value), patient insurance and payment history (prompt payments increase lifetime value), patient referrals (more number of referrals to friends and family, higher the lifetime value of the patient), and patient feedback (“like” or positive feedback for visits). Accordingly, patients with higher customer lifetime values are prioritized for appointments, all other things being the same. For example, if Patient A (higher lifetime value) and Patient B (transactional patient, low lifetime value) both provided time slots that encompass similar appointment slots, Patient A will receive priority on the best appointment slot, followed by Patient B.

As shown in FIG. 11, a manual override option 135 is provided. The smart scheduling process determines the best appointment time slot for a patient based on her availability, the service provider's past schedule history, the service provider's current schedule, and patient ranking. However, healthcare is inherently very difficult to forecast, unexpected delays can and do happen. For example, a doctor may get called into emergency surgery, necessitating that all following appointments be delayed or even rescheduled. In such unexpected cases the smart scheduler allows the service provider office staff to manually over-ride the appointment process and change appointments based on latest information. If such emergencies occur, the system provides a real-time in-app notification feature to inform the patient about the changed circumstances. It allows the patient to, with one tap, call the doctor office to reschedule, if the new suggested appointment time doesn't work with the patient's schedule. Because the patient mobile app is a native app (iOS, Android, etc.), notifications are real-time and always-on. So, the patient is able to receive up-to-date, real-time notifications from the doctor's office, allowing her to be always informed and in charge of her healthcare experience.

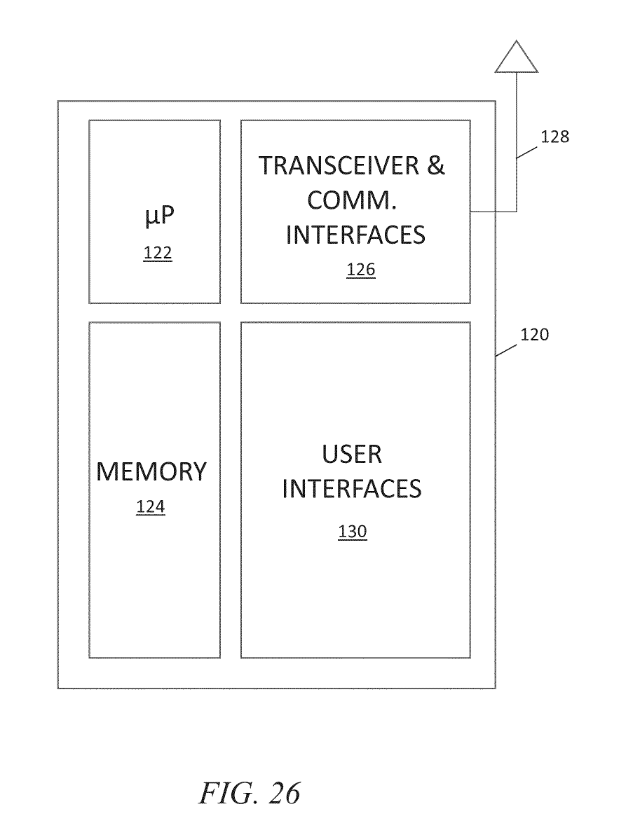

FIG. 26 is a simplified block diagram of an exemplary embodiment of a computing device such as a mobile terminal 140 capable of accessing the system and method for optimizing and streamlining the interaction and relationship between patients and healthcare providers. The mobile terminal 140 includes a microprocessor 142 that includes the logic to execute the software instructions stored in memory 144, and to access data stored in the memory 144. Memory 144 may include Random Access Memory (RAM), Read-Only Memory (ROM), and other types of memory devices. The mobile terminal 140 further includes a transceiver and communication interfaces for establishing a variety of communication channels including cellular, WiFi, Bluetooth, near-field, and other communication technologies now known or to be developed. The user may use the mobile terminal 140 to access the Internet to access websites, receive text messages, make cellular phone calls, and access various computer networks. The transceiver 146 is coupled to one or more antennae 148 for achieving radio frequency communication. The mobile terminal 140 further includes a number of user interfaces 150 including display screen which may be touch-sensitive, microphone, speakers, a keypad, and imaging capabilities. The user may use the variety of user interface devices 150 to enter data and receive information in a variety of formats.

The features of the present invention which are believed to be novel are set forth below with particularity in the appended claims. However, modifications, variations, and changes to the exemplary embodiments described above will be apparent to those skilled in the art, and the system and method described herein thus encompass such modifications, variations, and changes and are not limited to the specific embodiments described herein.

What is claimed is:

1. A system for optimizing and streamlining interaction and relationship between a user and service providers, comprising:
a first database configured to store a plurality of web pages of a web portal optimized for displaying on display screens of a variety of computing devices;
a second database configured to store profile data of a plurality of service providers, feedback data associated with the plurality of service providers, including feedback data associated with identified friends and families of the user; and
a computer server configured to access the second database to transmit the web pages to a computing device to:
receive an appointment scheduling input from the user;
prompt for and receive at least two preferred time slots from the user;
receive, in real-time, service provider availability for the received at least two preferred time slots from the user;
automatically and in real-time identify an appointment time for the user in response to the received two preferred time slots and service provider availability;
receive and store, from the user, an appointment scheduling confirmation for the appointment time;
automatically provide a reminder to the user of the scheduled appointment time;
receive a check-in for the scheduled appointment;
automatically prompt for and receive feedback about the service provider and appointment; and
automatically analyze the feedback from the user.

2. The system of claim 1, wherein the computer server is further configured to identify an appointment time in response to past scheduling history of the service provider.

3. The system of claim 1, wherein the computer server is further configured to:
determine and assign a lifetime value to the user; and
identify an appointment time in response to the lifetime value assigned to the user.

4. The system of claim 1, wherein the computer server is further configured to rank the user based on an assigned lifetime value, and prioritize in-demand appointment times in response to the user's assigned lifetime value.

5. The system of claim 1, wherein the computer server is further configured to prompt for and receive, from the user, a reason for the appointment, and determine a CPT (current procedural terminology) code for the appointment.

6. The system of claim 1, wherein the computer server is further configured to prompt for and receive two two-hour time slots from the user.

7. The system of claim 1, wherein the computer server is further configured to automatically and in real-time identify a twenty-minute appointment slot for the user in response to the received two preferred time slots and service provider availability.

8. The method of claim 1, wherein the computer server is further configured to automatically determine whether the feedback is positive, neutral, or negative.

9. The method of claim 1, wherein the computer server is further configured to perform semantic evaluation of textual input to determine whether the feedback is positive, neutral, or negative.

10. The method of claim 1, wherein the computer server is further configured to perform voice recognition of verbal input to determine whether the feedback is positive, neutral, or negative.

11. The method of claim 1, wherein the computer server is further configured to automatically determine whether the feedback is positive, neutral, or negative, and immediately relay a received negative feedback to the service provider.

12. A method for optimizing and streamlining interaction and relationship between a user and service providers, comprising:
receiving an appointment scheduling input for a service provider from the user;
prompting for and receiving two preferred time slots from the user;
receiving service provider availability for the received two preferred time slots;
automatically identifying an appointment time for the user in response to the received two preferred time slots and service provider availability;
receiving and storing, from the user, an appointment scheduling confirmation for the appointment time;
automatically providing a reminder to the user of the scheduled appointment time;
receiving a check-in for the scheduled appointment;
automatically prompting for and receive feedback about the service provider and appointment; and
automatically analyzing the feedback.

13. The method of claim 12, wherein automatically analyzing the feedback comprises determining whether the feedback is positive, neutral, or negative.

14. The method of claim 12, wherein automatically analyzing the feedback comprises semantic evaluation of textual input to determine whether the feedback is positive, neutral, or negative.

15. The method of claim 12, wherein automatically analyzing the feedback comprises voice recognition of speech input to determine whether the feedback is positive, neutral, or negative.

16. The method of claim 12, further comprises automatically prompting for and receiving, from the user, a reason for the appointment, and determine a CPT code for the appointment.

17. The method of claim 12, wherein prompting for and receiving two preferred time slots comprises prompting for and receiving two two-hour time slots from the user.

18. The method of claim 12, wherein automatically and in real-time identifying an appointment time comprises identifying a twenty-minute appointment slot.

19. A system for optimizing and streamlining interaction and relationship between a user and service providers, comprising:
a first cloud-based database configured to store a plurality of web pages of a web portal optimized for displaying on display screens of a variety of computing devices;
a second cloud-based database configured to store profile data of a plurality of service providers, feedback data associated with the plurality of service providers, including feedback data associated with identified friends and families of the user; and
a computer server configured to access the second cloud-based database to transmit the web pages to a mobile app executing on a mobile computing device, the computer server configure to:
receive user preferences for a service provider;
automatically create, in real-time, from the stored profile data of the plurality of service providers stored in the second cloud-based database, a rank ordered list of at least one service provider in response to the user preferences, the user's healthcare insurance data, and feedback data associated with the plurality of service providers;
prompt for and receive two preferred time slots from the user;
receive, in real-time, service provider availability for the received two preferred time slots; and
automatically and in real-time identify an appointment time for the user in response to the received two preferred time slots and service provider availability. receive and store, from the user, an appointment scheduling confirmation for the appointment time;
automatically prompt for and receive feedback about the service provider after the appointment; and
automatically analyze the feedback.
